(19) United States
(12) Patent Application Publication
(10) Pub. No.: US 2018/0154249 A1
(43) Pub. Date: Jun. 7, 2018

(54) Crossword and Anagram Game and Method of Playing Such a Game

(71) Applicant: Dennis Wik, Potter Valley, CA (US)

(72) Inventor: Dennis Wik, Potter Valley, CA (US)

(21) Appl. No.: 15/822,844

(22) Filed: Nov. 27, 2017

Related U.S. Application Data
(60) Provisional application No. 62/429,173, filed on Dec. 2, 2016.

(51) Int. Cl. A63F 3/04; A63F 3/00; A63F 13/822; A63F 9/00; A63F 13/92

(52) U.S. Cl. CPC A63F 3/0423; A63F 3/00529; A63F 3/00694; A63F 13/822; A63F 2003/00996; A63F 9/0098; A63F 13/92; A63F 2003/0428; A63F 2003/0063; A63F 3/0023

(57) ABSTRACT

A method of playing a combination crossword and anagram game is disclosed. By manipulating movable tabular letter tiles or their digital, electronic or other equivalents, players take turns building a single free-form grid of intersecting words, crossword style, on any suitable surface. Each letter in each new word is worth one point, so game play favors long words. There is no game board, so the grid can grow in any direction, without constraint. Words are not locked in place, so they can be relocated at will to a different part of the grid in order to make room for the placement of new words. Furthermore, any individual word in the grid can be changed into another word by the addition and/or subtraction of letters, or even detached from the grid so that its letters can be used to create a new word. The game encourages and rewards anagrams.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### 1. Field of the Invention

The present invention relates generally to word games, more specifically those in which players place tabular letter tiles in such a way as to form a grid in which words intersect at right angles, crossword style.

### 2. Description of the Related Art

Tile-based crossword games have been in widespread popular use since the introduction of Scrabble® in 1947 (U.S. Pat. No. 2,752,158). That game relies on letter tiles that have differing point values, and on premium squares on a unique game board that double or triple letter or word scores. Game play can be intense and thoughtful as players seek to form a word out of the seven letters at their disposal and place it on the board in a manner that will earn the most points, with the result that the game is more suitable for adults than for children. A yearly nationwide competition draws incredibly adept players with phenomenal vocabularies.

The main drawback with this very popular game and its derivatives is that the game board that makes it so challenging is at the same time very confining, in that letters that have been placed on the board may not thereafter be moved. And since each player has access to only seven letters at a time, an unfortunate plethora of vowels or hard-to-place consonants can make it difficult to form a substantive word.

Bananagrams®, which came on the market in 2006, offers radically different game play. It discarded the idea of playing on a game board in favor of the wide-open environment of an ordinary table. It also got rid of the notion of taking turns. Instead, players race to be the first to finish their individual crossword grids. The first player to finish an acceptable crossword grid in this racing game is the winner. Game play in this every-man-for-himself environment is boisterous, hectic, entertaining and educational, so it is not surprising that Bananagrams is especially popular among children. The first nationwide competition was held in 2016, for fourth- to sixth-graders. Bananagrams neither requires nor rewards deep thought of the type usually associated with Scrabble.

Cernansky (US Patent Application 20100109247) discloses a crossword game without a game board in which individual letter tiles have tongues and notches, much like the pieces of a crossword puzzle, so that the entire grid can be rotated to face each player in turn. The game play is much like that of the Scrabble derivative UpWords in that words once placed are locked into the grid but may be turned into new words by stacking letter tiles on top of those already in the grid.

Bazarko (U.S. Pat. No. 8,672,328) discloses another game without a game board in which players attach letters to those already on the playing surface to form words. The distinguishing feature is that each round letter tile has a rounded concavity of such a radius that the convex side of another tile nests in it. The tiles that form any given word are therefore not locked into a right-angle grid, but can “snake” and bend irregularly as words are extended. Tiles that are placed in the center cannot be moved to make room for new tiles. This restriction has the effect of locking words down as effectively as a game board would have done.

Tile-based word games can be played, mutatis mutandis, with letter tiles that are not square. A search of prior art disclosed three patents that use hexagonal tiles. Kowalczyk (U.S. Pat. No. 7,118,110) discloses a game in which each letter tile bears a letter or symbol; it is played on a game board that has bonus spaces and penalty spaces.

Hughes (U.S. Pat. No. 4,190,255) discloses a game in which each letter tile bears a letter; it is played on a game board that has bonus spaces for multiplying letter scores and word scores.

Leban (U.S. Pat. No. 5,108,109) discloses a game that does not use a game board, but eight of its tiles bear an ambigram rather than a letter of the alphabet. One such ambigram is a symbol that looks somewhat like a backwards numeral: 3. It can be taken for a B when viewed right side up, or as an E when viewed upside down. Thus, the intersecting word pair that reads SNOB/BX when viewed right side up reads EONS/EX when viewed upside down.

There is a need for a game that offers unlimited freedom in the size and shape of the grid (i.e., no game board); a large supply of letters at the players' disposal at each turn; a series of operations that allow anagramming and modification of individual words after they have been placed within the grid; and multiple different ways of adding new words to the crossword grid; and means of changing the shape of the crossword grid itself.

The Game according to the present invention addresses those needs and extends the concepts of the prior art in that it is played on an ordinary table, but is not a racing game, and also in that players take turns in building a single Crossword Grid, but not within the rigid confines of a game board. Additionally, words in the grid can be modified in a number of different ways and may be cannibalized so that their letters may be used in the formation of new words elsewhere in the Crossword Grid. Words may also be moved from one part of the Crossword Grid to another in order to make room for the placement of new words, and may be transposed from horizontal to vertical orientation (or vice versa) as required for spatial reasons.

The Game also has features that take account of differing ages and skill levels among players so that children and adults can play together, learn from each other, and benefit from each other's company.

### BRIEF SUMMARY OF THE INVENTION

This invention discloses a game in which players take turns as they manipulate movable tabular letter tiles (or their digital, electronic or other equivalents) to construct a single grid of intersecting words, crossword style, without the use of a game board. Novel features are as follows:

Any existing word in the crossword grid may be anagrammed, shortened, lengthened, moved from one place to another, combined with another word to create a new word, transposed between horizontal and vertical orientation in order to make room for the placement of a new word, or removed from the crossword grid entirely so that its Letter tiles may be reused for the creation of a longer word. Several intersecting words may be detached from the crossword grid as a unit and then reattached elsewhere in order to facilitate the placement of the new word for the turn.

At the beginning of a game, all of the letter tiles are spread on the playing surface face down to form a stockpile, and then seven letter tiles are turned face up to form a common pile. The upward-facing letter tiles in the common pile are available for the use of each player at each turn throughout the game. The common pile is replenished to its normal capacity at the end of each turn.

In forming a new word, a player may also reuse some or all of the letter tiles of an existing word that is being modified. As a result, the player often has more than the fourteen letter tiles of the letter tray and the common pile to work with, right up until the stockpile runs out.

With so many letter tiles available, the minimum word length has been set at four letter tiles, compared to the norm of two letter tiles in existing games. In practice, the average length of the very first word placed in the crossword grid while playing the game is six letter tiles. Words four letter tiles in length typically appear only in the last couple of moves, during the end game.

### BRIEF DESCRIPTION OF THE SEVERAL VIEWS OF THE DRAWINGS

The accompanying drawings serve to illustrate and explain the nature of The Game, the method for playing it, and the multiple Moves and Maneuvers that enable modification of individual Existing Words in the Crossword Grid and the very structure of grid itself.

FIG. 1 shows The Game's Apparatus.

FIG. 2 shows The Game's letter distribution.

FIG. 3 shows The Game's flow chart.

FIG. 4 shows how the first few words might be entered into a Crossword Grid at the beginning of a game.

FIG. 5 shows how a player anagrammed an Existing Word.

FIG. 6 shows how a player modified an Existing Word.

FIG. 7 shows a completed Crossword Grid built without The Game's letter manipulation techniques.

FIG. 8 shows a completed Crossword Grid built with full use of The Game's letter manipulation techniques.

FIGS. 9-11 show how a player detached the Letter Tiles of an Existing Word in the Crossword Grid and reattached them elsewhere in order to make room for the placement of a new word.

FIG. 12 shows how a player detached the Letter Tiles of two Existing Words in the Crossword Grid and reattached them elsewhere, simultaneously transposing both of said Existing Words between horizontal and vertical orientations.

FIG. 13 shows how a player modified an Existing Word.

FIG. 14 shows how a player anagrammed an Existing Word.

FIG. 15 shows how a player combined two Existing Words into a single new word.

FIG. 16 shows how a player released a desired Letter Tile from an Existing Word and then used said released Letter Tile in the formation of a new word.

FIG. 17 shows how a player detached the Letter Tiles of an Existing Word in the Crossword Grid and moved them elsewhere as part of the process of creating a new word.

FIG. 18 shows how a player detached the Letter Tiles of two Existing Words in the Crossword Grid and moved them elsewhere as part of the process of creating a new word.

FIG. 19 shows how a player replaced a Letter Tile at the junction of two Existing Words in the Crossword Grid with a Letter Tile having a different Character Value than that of the original Junction Letter, thereby creating two new words at one stroke.

FIG. 20 shows how a player removed certain Letter Tiles from an Existing Word in the Crossword Grid, leaving behind a Stub Word that was a new word in itself, and then used said removed Letter Tiles in the creation of a second new word.

FIG. 21 shows how a player abutted a Letter Tile of a new word against a Letter Tile in an Existing Word in the Crossword Grid in such a way that said Existing Word was transformed into a second new word, as a byproduct.

FIG. 22 shows how a player inserted an entire new word crosswise into an Existing Word in the Crossword Grid in such a way as to change said Existing Word, without any rearrangement of its Letter Tiles, into a second new word.

FIG. 23 shows how a player placed the Letter Tiles of a new word in such a way as to intersect two Existing Words in the Crossword Grid, said new word thus becoming one side of a perfect square of Letter Tiles.

FIG. 24 shows how a player detached the Letter Tiles of an Existing Word in the Crossword Grid, anagrammed them, and moved them to a different location within said Crossword Grid in such a way as to create a new word without either importing any Letter Tiles into said Crossword Grid or exporting any Letter Tiles from said Crossword Grid.

FIG. 25 shows how a player detached the Letter Tiles of an Existing Word in the Crossword Grid, anagrammed them, and reattached them to a different Junction Letter in said Existing Word in such a way as to create a new word without either importing any Letter Tiles into said Crossword Grid or exporting any Letter Tiles from said Crossword Grid.

FIG. 26 shows how a player slid the Letter Tiles of an entire Existing Word in the Crossword Grid across (perpendicular to) its Intersecting Word in such a way that one of said Letter Tiles became a new Junction Letter in said Intersecting Word, said new Junction Letter having a different Character Value than the original Junction Letter, with the result that said Intersecting Word was turned into a new word.

FIG. 27 shows a completed Crossword Grid that resulted when two Letter Sets were combined.

FIG. 28 shows a representation of an electronic embodiment of The Game.

### DETAILED DESCRIPTION OF THE INVENTION AND THE RULES FOR PLAYING THE GAME

In the following detailed description of the invention, reference is made to the accompanying drawings which form a part of the disclosure and which show by way of illustration, and not of limitation, specific embodiments by which the invention may be practiced. The drawings, the foregoing discussion, and the following description are exemplary and explanatory only, and are not intended to limit the scope of the invention or its application in any manner.

Glossary of Terms

Anagram: As a Verb: To rearrange a group of Letter Tiles in such a way as to form a new word. As a Noun: A new word that is formed by rearranging the Letter Tiles of an Existing Word, adding none and removing none.

Bonus Point: One extra point for each of certain Letter Tiles placed during the execution of a Bonus Move.

Bonus Move: A Move which earns points above and beyond those awarded for each Letter Tile in a new word that is entered into the Crossword Grid during a player's turn.

Character Value: The letter of the alphabet that is inscribed on the display side of a Letter Tile.

Common Pile: The supply of Letter Tiles, face up on the playing surface, from which players may draw Letter Tiles in the process of adding a new word to the Crossword Grid or modifying an Existing Word, and into which players place Letter Tiles that are displaced from Existing Words during execution of a Move. The Common Pile may hold an unlimited number of Letter Tiles at any given time.

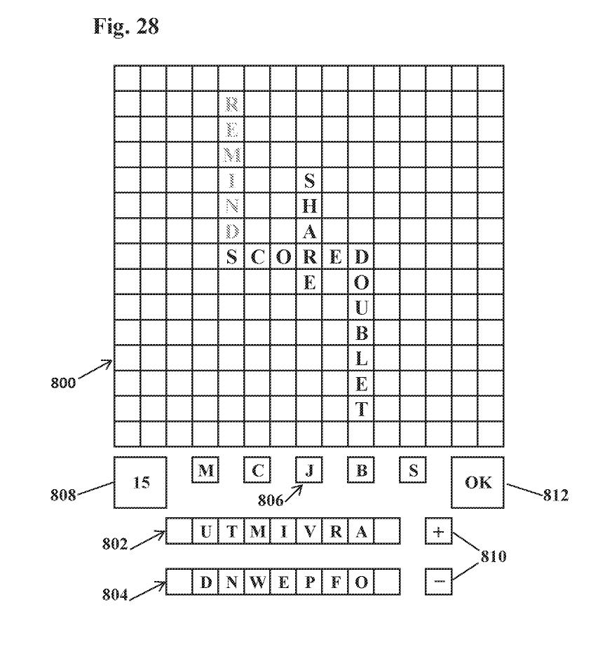

Common Pile Panel: The depiction of the Common Pile in the electronic version of The Game, illustrated in FIG. 28 as numbered item 804.

Connected Word: A word in the Crossword Grid that intersects the Existing Word in the Crossword Grid that is being moved from one part of the grid to another. (A Connected Word may be part of an entire section of the Crossword Grid is moved as a unit.)

Crossword Grid: The array of words that results as players arrange square Letter Tiles to create new words that intersect at right angles, in the manner of a crossword puzzle.

Crossword Grid Panel: The depiction of the Crossword Grid in the electronic version of The Game, illustrated in FIG. 28 as numbered item 800.

End Game: The final few Moves in playing a round of The Game. The End Game begins when the Stockpile is exhausted and one player empties their Letter Tray.

Existing Word: A word that is already in the Crossword Grid.

Free Letter Tile: Any Letter Tile in an Existing Word that is not a Junction Letter.

Game, The: The game that is disclosed in this invention.

Intersecting Word: A word in the Crossword Grid to which another word is attached by means of a shared Junction Letter.

Junction Letter: A Letter Tile that is shared by two Intersecting Words in a Crossword Grid

Letter Tile: A flat token (physical or virtual) that displays one letter of the alphabet on one face.

Letter Set: The collection of the Letter Tiles that is provided with The Game.

Letter Tray: The holder for a player's Letter Tiles. It is refilled to capacity after each turn, as necessary.

Letter Tray Panel: The depiction of the Letter Tray Panel in the electronic version of The Game, illustrated in FIG. 28 as numbered item 802.

Maneuver: A method of manipulating Letter Tiles that does not in itself result in the creation of a new word.

Move: A method of creating one or more new words by manipulating Letter Tiles taken from the Stockpile, the Common Pile, and Existing Words in the Crossword Grid, in any combination.

Move Icon: A symbol in the electronic version of The Game which invokes a particular letter manipulation technique, to be employed as soon as the player clicks an appropriate Letter Tile in the display.

OK Button: The depiction of the equivalent of the Enter key on a standard keyboard by means of which the player signals readiness to proceed to the next step in playing the electronic version of The Game, illustrated in FIG. 28 as numbered item 810.

Polyanagram Play: A method of creating one or more new words by manipulating only Letter Tiles that are already in Existing Words in the Crossword Grid.

Polyanagram: Any word that can be created using only Letter Tiles that are already in Existing Words in the Crossword Grid. No Letter Tiles are exported from the Crossword Grid, and no Letter Tiles are imported into the Crossword Grid.

Scoring Level: An optional scale that allows players of mixed abilities to play together by limiting the scores of the more skilled individuals.

Stockpile: The supply of unused Letter Tiles, face down on the playing surface, that players draw upon in order to refill their individual Letter Trays and the Common Pile after each turn.

Stockpile Counter: A display element in the electronic version of The Game that shows the number of Letter Tiles that remain in the Stockpile.

Stub Word: The word that is spelled out by the remaining Letter Tiles of an Existing Word after it has been shortened.

Appurtenances

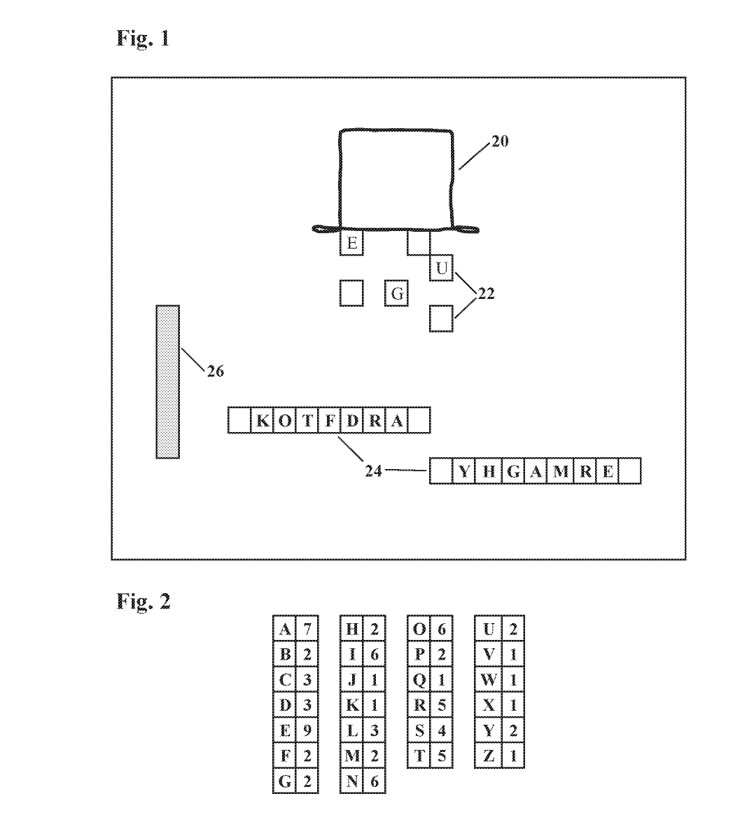

FIG. 1 shows the components required to play the preferred embodiment of The Game, namely:
One small plain sack with Drawstring 20 of a size to hold one Letter Subset of eighty Letter Tiles 22, said Letter Tiles having no markings on the back side;
Two Letter Trays 24, each of said Letter Trays being filled with its usual complement of seven Letter Tiles, the purpose of said Letter Trays being to maintain each player's Letter Tiles in a semi-upright position during the game, out of the view of the other players; and
One Straight Edge 26. It is used to maintain the Letter Tiles of Existing Words in the Crossword Grid in neat rows and columns on the playing surface.

The preferred embodiment as discussed in this Description utilizes Letter Tiles that show characters corresponding to the English language. The non-limiting letter distribution of the Letter Tiles in The Game is shown in FIG. 2. Each letter of the alphabet is represented on at least one Letter Tile and occurs within the Letter Set roughly in proportion to its occurrence in everyday use of the language, as adjusted by noting the letters that often seemed to be underrepresented during play as well as those that were most often left over at the end of play. It is to be understood that with appropriate adjustments, The Game may be played in many other languages with different sets of letters, allowances having been made for the frequency of occurrence of the letters in words that are in common use among speakers of the subject language.

Object of the Game

The object of the game is for the players, taking turns, to use up all of the Letter Tiles that are in use by a process of constructing a single Crossword Grid. One point is awarded for each Letter Tile in each new word that is incorporated into the Crossword Grid during the course of the game, and Bonus Points are awarded for certain Moves. The player with the highest score at the end of play is the winner.

Method of Playing the Game

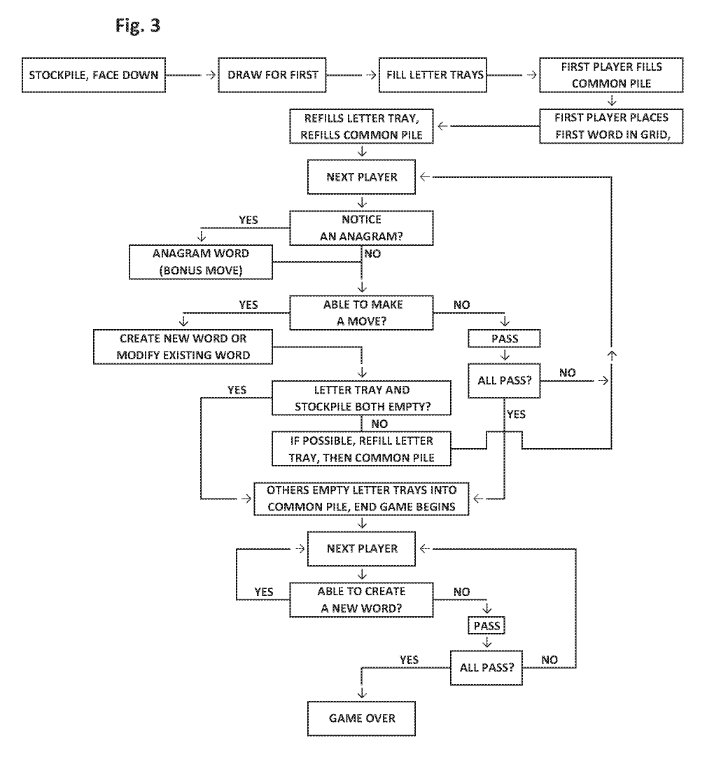

The game play flow chart for the preferred embodiment is shown in FIG. 3.

Players begin by spreading the Letter Tiles of the Letter Set on the playing surface, Character Value side down, to form the Stockpile. They then draw one Letter Tile apiece. The person who draws the Letter Tile bearing the Character Value nearest the beginning of the alphabet goes first. Players who tie for first draw again.

Players each draw seven Letter Tiles and place them on their respective Letter Trays. The person who has the first turn then draws an additional seven Letter Tiles and places them on the playing surface, Character Value side up, to form the Common Pile. These Letter Tiles will be available to each player at each turn.

The first player places the first word on the playing surface, leaving room on all sides for the Crossword Grid to grow. The Letter Tiles may come from their Letter Tray and from the Common Pile in any combination. A word must have at least four letters, may not contain capital letters, and may not appear in the Crossword Grid more than one time during the game, either directly or as the result of modifying a word.

Upon completion of the turn, the first player draws sufficient Letter Tiles from the Stockpile to refill their Letter Tray to seven Letter Tiles and then to refill the Common Pile to seven Letter Tiles, as necessary. Play passes to the left.

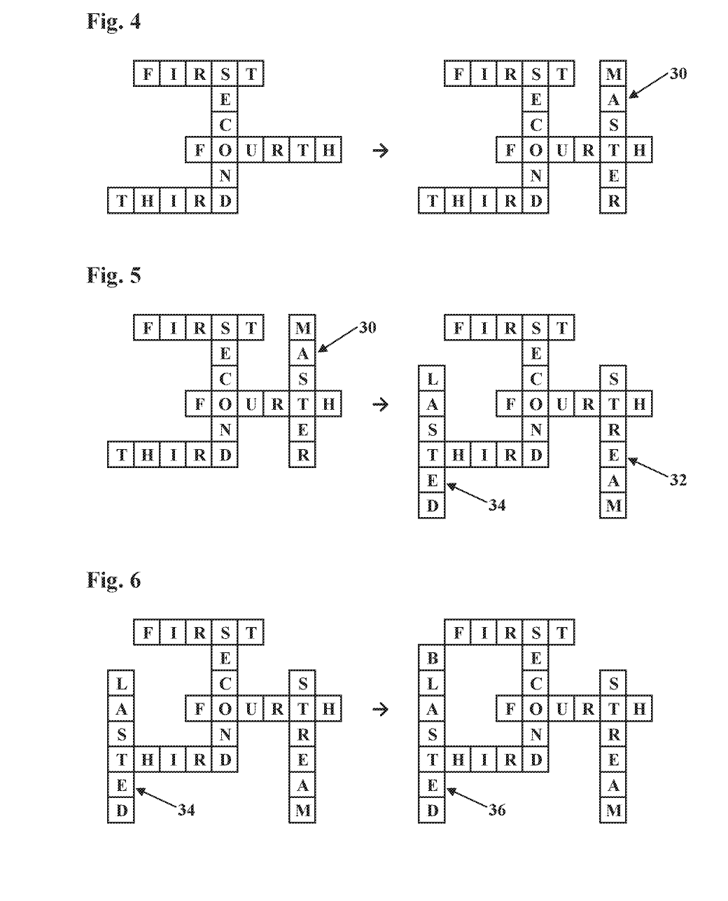

The left-hand panel in FIG. 4 shows how the players placed the first four words in a new grid at the beginning of a game. The words themselves indicate the order in which they were created. In the right-hand panel, the player taking the next turn has added the new word MASTER 30. (The large rightward-pointing arrow→in these figures stands for the operation being performed, and also indicates the direction of the action.)

FIG. 5 shows how the following player anagrammed the Existing Word MASTER 30 into the new word STREAM 32. This technique can be employed once per turn and earns Bonus Points. The player still gets to place the new word for the turn—in this case, LASTED 34.

FIG. 6 shows how the following player modified the Existing Word. LASTED 34, lengthening it to BLASTED 36. The game proceeds in this manner as players add new words and modify Existing Words. After each turn they refill first their Letter Tray and then the Common Pile to the stated capacities, as necessary. If they cannot make a Move, they pass.

If a spelling error is noticed as the word is being entered into the Crossword Grid, the player must correct it then and there. Once play has resumed, however, a misspelled word can only be corrected in the course of a legal Move. Given the nature of The Game, said misspelled word will probably be modified anyway during the ordinary course of play.

Eventually the Stockpile runs out. Game play continues, carried by the Letter Tiles that remain in the players' Letter Trays and the Common Pile, but as soon as any one player makes a Move that empties their Letter Tray, the End Game begins. At that point the other players immediately empty their Letter Trays into the Common Pile, and the next player resumes play under different rules.

During said End Game, none of the Existing Words in the Crossword Grid may be modified in any way except by anagramming, although they may be relocated to a different part of the grid as needed for the placement of a new word. The only source of Letter Tiles is the Common Pile, and the only way to create a new word is to place Letter Tiles around or among the Letter Tiles that are already in Existing Words. Words that are placed in the Crossword Grid during the End Game are also locked down and may not be changed by subsequent players, except that they too may be anagrammed. Play ends when all players have passed in turn.

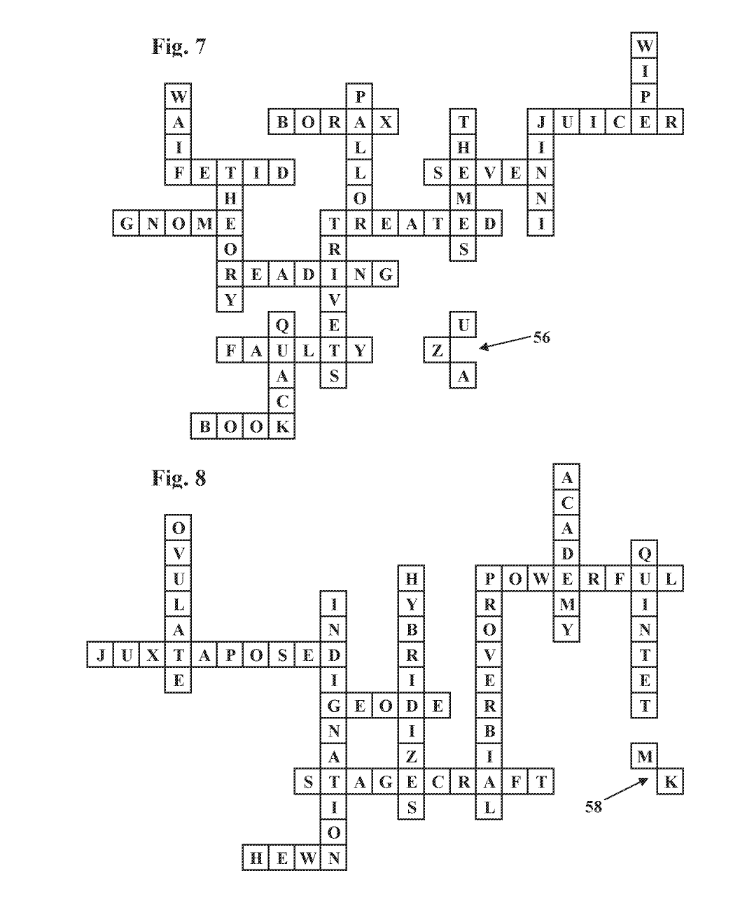

Most of the action in The Game involves manipulation of Letter Tiles to modify words that are already in the Crossword Grid. This key innovation makes a real difference, as is demonstrated in side-by-side comparison of two Crossword Grids built by the same two players, as illustrated in FIGS. 7 and 8.

In the first trial game, shown in FIG. 7, the players built a Crossword Grid simply by adding one word at a time: seventeen turns, seventeen words. (Three Letter Tiles 56 remained in the Common Pile at the end of the game.) In the second trial game, illustrated in FIG. 8, the players made unrestricted use of The Game's Moves and Maneuvers as they created a total of twenty words, but they dismantled and modified so many that only eleven survived until the end of the game. Although there were fewer words overall in this second grid, they were longer and more interesting, and the game play had been much more engaging. (Two Letter Tiles 58 remained in the Common Pile.)

Description of the Game's Maneuvers

A Maneuver method is a grid-level operation that allows the player to move one or more Existing Words from one part of the Crossword Grid to another in order to make room for the placement of the new word for the turn, or to release one or more letters from an Existing Word for use during said turn. The Game discloses six Maneuvers, each of which is described in detail below.

Relocate a Word Maneuver

The Game always allows the player to move an Existing Word that is blocking placement of a new word. The only requirement is that the spelling of the word be maintained. With the Relocate a Word Maneuver, the player detaches the Letter Tiles of an Existing Word and reattaches them to an accessible Letter Tile with the same Character Value in a different Existing Word. Any Connected Words travel along.

In the example shown in FIG. 9, the player detached the Letter Tiles of the Existing Word CALF 200 from their Junction Letter C 202 in the Existing Word SPACE 204 and reattached them to a new Junction Letter with the same Character Value C 206 in the Existing Word. SCARF 208. The Maneuver thus cleared the way for placement of the new word for the turn LEVER 210.

Parallel Slider Maneuver

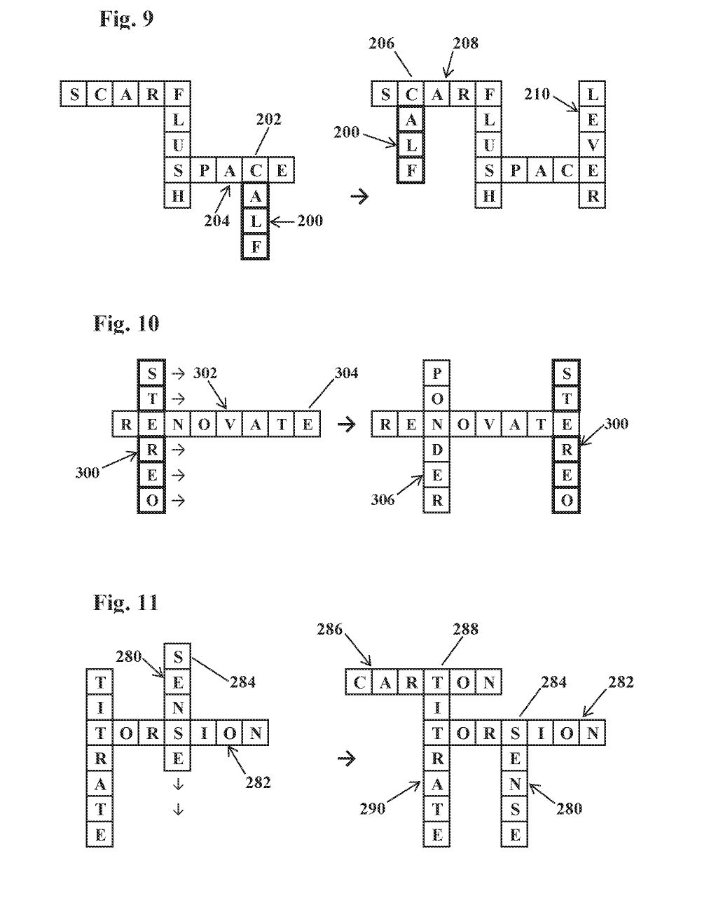

With this Maneuver the player detaches the Letter Tiles of an Existing Word from their Junction Letter and slides them along their intersecting Word in such a way as to come to rest on a new Junction Letter that has the same Character Value as the original Junction Letter. In the example shown in FIG. 10, the player detached the Letter Tiles of the Existing Word STEREO 300 and slid them in a direction parallel to their Intersecting Word RENOVATE 302 in such a way that they came to rest on the second instance of a Letter Tile with the Character Value E 304 in said Intersecting Word RENOVATE 302, which thus became the new Junction Letter. This cleared the way for the creation of the new word PONDER 306.

Perpendicular Slider Maneuver

With this Maneuver the player slides an entire Existing Word across its Intersecting Word in such a way that one of its component Letter Tiles that has the same Character Value as the original Junction Letter becomes the new Junction Letter. In the example shown in FIG. 11, the player slid the Existing Word SENSE 280 downward, perpendicular to their Intersecting Word TORSION 282, until the first Letter Tile S 284 of said Existing Word SENSE 280 became the new Junction Letter within the Intersecting Word TORSION 282. The player then built the new word CARTON 286 on the newly accessible Junction Letter T 288 of the Existing Word TITRATE 290.

Transpose Maneuver

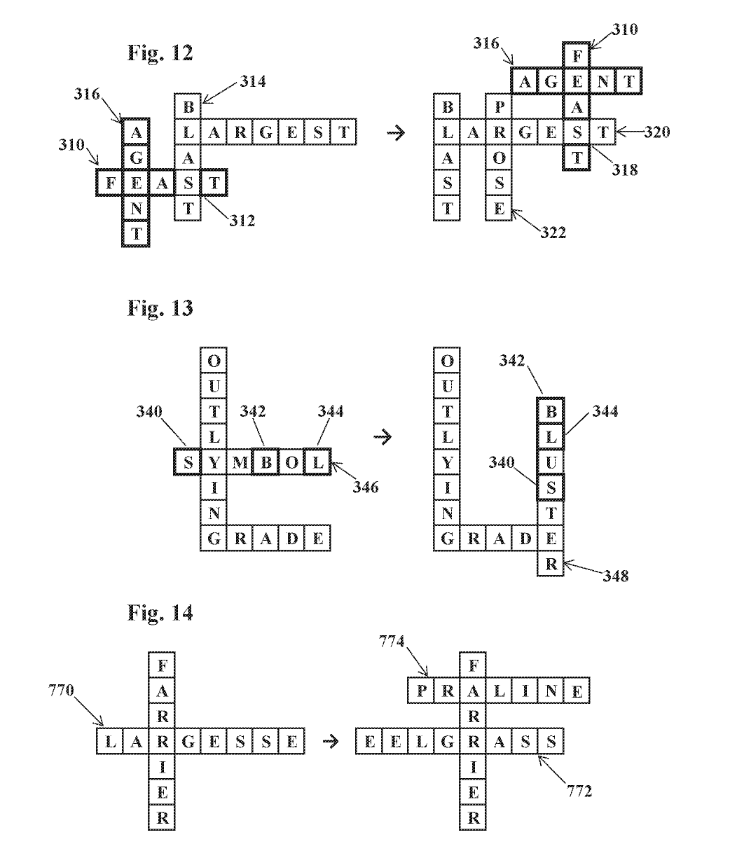

When words are moved to a new location, they may not fit unless they are changed from horizontal to vertical orientation, or vice versa. In the example illustrated in FIG. 12, the player first detached the Letter Tiles of the Existing Word FEAST 310 from their Junction Letter S 312 in its Intersecting Word BLAST 314, along with all of the Letter Tiles of the Connected Word AGENT 316, and then reattached the entire grid segment to another Letter Tile that also had the Character Value S 318 in the new Intersecting Word LARGEST 320. This required the player to manipulate the Letter Tiles of both FEAST 310 and AGENT 316 in such a way as to transpose them between horizontal and vertical orientations. The Maneuver created space for the creation of the new word PROSE 322.

Description of the Game's Moves

A Move method is word-level technique that involves the manipulation of Letter Tiles in such a way as to create a new word. The Game discloses twelve Moves, each of which is described in detail below.

Modify a Word Move

With this common and very important Move, the player detaches the Letter Tiles of an Existing Word and then swaps Letter Tiles in and out in such a way as to create a new word, building said new word on any Junction Letter in any Existing Word. The new word may not consist of fewer Letter Tiles than did the word that was dismantled. In the example shown in FIG. 13, the player detached the Letter Tiles of the Existing Word SYMBOL 346, swapped Letter Tiles in and out, then anagrammed the collection in such a way as to create the new and longer word for the turn BLUSTER 348. The numerals associated with the detached Letter Tiles S 340, B 342, and L 344 show how they were scrambled as they were incorporated into the new word.

Simple Anagram Bonus Move

With this Move the player rearranges the Letter Tiles within an Existing Word to create a new word, adding no Letter Tiles and removing none. This Move earns Bonus Points, and is allowed only once per turn. The player still goes on to create and score the new word for the turn. In the example shown in FIG. 14, the player anagrammed the Letter Tiles of the Existing Word LARGESSE 770 into the new word EELGRASS 772, then went on to create the new word for the turn PRALINE 774.

Combine Words Move

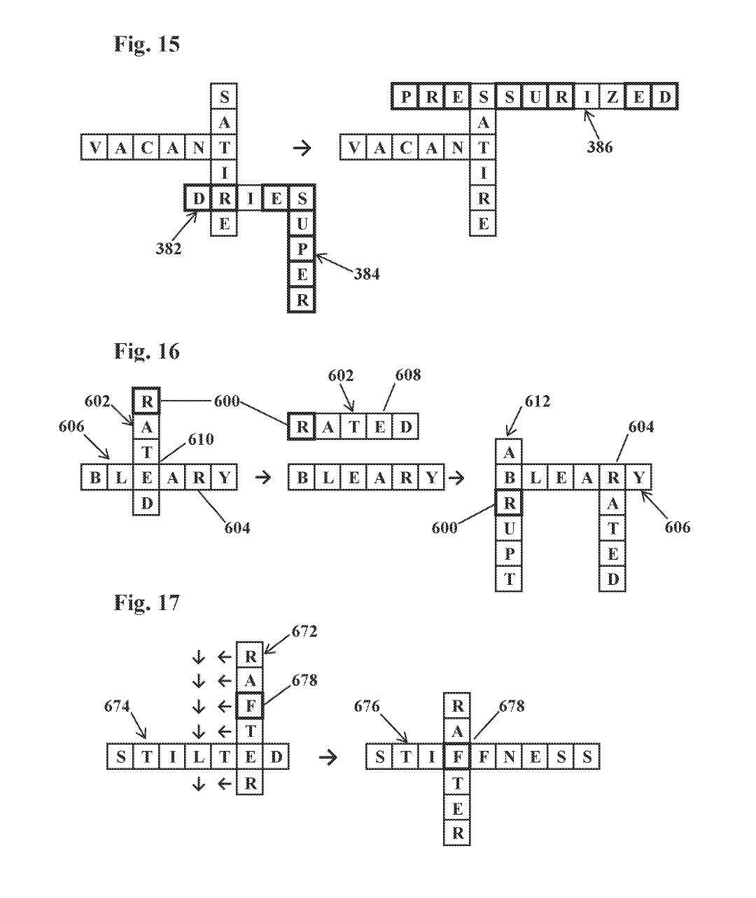

With this Move the player detaches the Free Letter Tiles of two words and then uses them to create a new word, swapping Letter Tiles in and out as necessary. The new word must consist of at least as many Letter Tiles as were in the longer of the two words that were dismantled. In the example shown in FIG. 15, the player detached all of the Letter Tiles of the Existing Words DRIES 382 and SUPER 384, swapped some Letter Tiles in and out, and then combined the collection in such a way as to create the new, longer word. PRESSURIZED 386.

Letter Trade Move

This Move allows the player to obtain a Letter Tile with a specific Character Value from an Existing Word. The player does this by detaching the Letter Tiles of an Existing Word, one of which has the desired Character Value, and reattaching them to another Junction Letter elsewhere that also has the desired Character Value. One of the Letter Tiles with the desired Character Value is left over and is immediately used in the creation of the new word for the turn. The player must also provide a copy of the original Junction Letter.

These steps are illustrated in FIG. 16. The player needed a Letter Tile with the Character Value R, and found one (R 600) in the Existing Word RATED 602. Then they found another Letter Tile with the Character Value R 604 in an unobstructed location within the Existing Word BLEARY 606.

The player detached the Letter Tiles of the Existing Word RATED 602, reconstituted the entire word RATED 602 by providing a copy E 608 of its original Junction Letter E 610 (as shown in the center panel), and overlaid the reconstituted word RATED 602 on the Existing Word BLEARY 606 in such a way that the leftover Letter Tile R 600 was then available for use in the creation of the new word for the turn ABRUPT 612.

Compound Slider Move

With the Compound Slider Move, the player slides Letter Tiles of an Existing Word both across and along (both perpendicular to and parallel to) their Intersecting Word. The Move has two modes. In the first mode, the player detaches the Letter Tiles of an Existing Word and slides them both along and across their Intersecting Word in such a way that one of said Letter Tiles becomes a new Junction Letter within said Intersecting Word. This movement changes or begins to change the Intersecting Word into the new word for the turn. The word that is slid remains unchanged.

As shown in FIG. 17, the player detached the Letter Tiles of the Existing Word RAFTER 672 from their Intersecting Word STILTED 674 and then slid them first to the left along (parallel to) said Intersecting Word, and then downward across (perpendicular to) said Intersecting Word. The player then swapped Letter Tiles in and out of said Intersecting Word STILTED 674 in such a way as to create the new word for the turn, STIFFNESS 676, the Letter Tile F 678 of said Existing Word RAFTER 672 becoming a new Junction Letter 678 within said new word STIFFNESS 676.

Multiple Slider Move

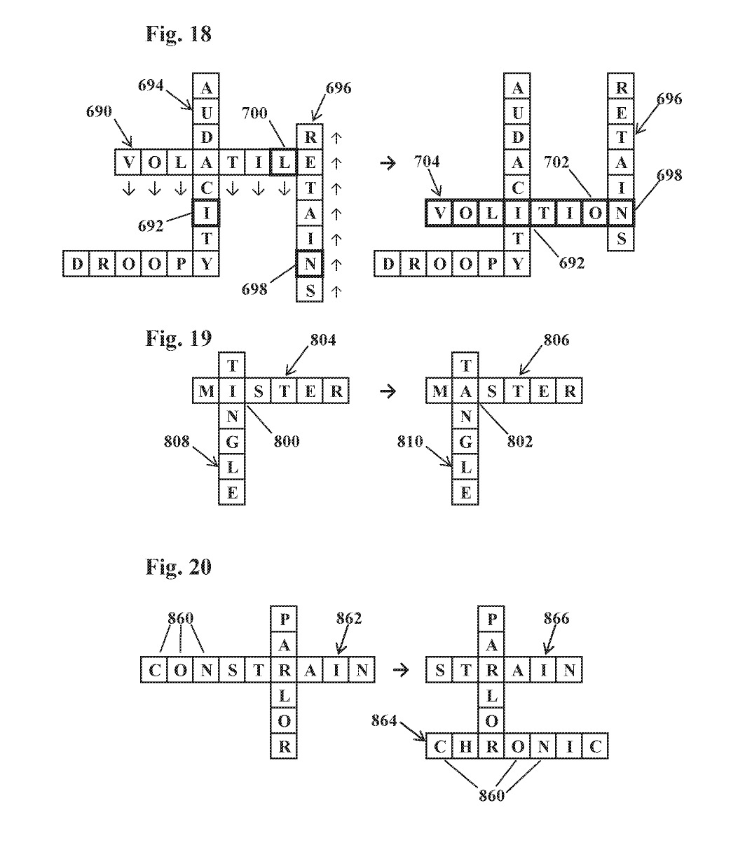

With the Multiple Slider Move the player slides the Letter Tiles of two or more Existing Words, possibly in different directions, to create a new word. In the example shown in FIG. 18, the player first executed a Parallel Slider Move with the detached Letter Tiles of the Existing Word VOLATILE 690, moving them downward to the new Junction Letter 1692 in their Intersecting Word AUDACITY 694. Next, the player executed a Perpendicular Slider on the Existing Word RETAINS 696, moving all of its Letter Tiles upward in such a way that its penultimate Letter Tile N 698 became a second Junction Letter in the new Intersecting Word that was being formed. Finally, the player swapped out the Letter Tile L 700 and replaced it with the new Letter Tile O 702 to complete the new Intersecting Word VOLITION 704.

Junction Letter Move

With the Junction Letter Move, the player changes a Junction Letter, thereby turning both Intersecting Words into new words. In the example shown in FIG. 19, the player replaced the original Junction Letter I 800 with a new Junction Letter A 802. This changed the Existing Word MISTER 804 into MASTER 806 and simultaneously changed the Existing Word TINGLE 808 into TANGLE 810. Both words were scored.

Poach Letters Bonus Move

With the Poach Letters Bonus Move, the player removes some Letter Tiles from an Existing Word—from a prefix, from inside the word, or from a suffix, in any combination. The Letter Tiles in the remaining Stub Word, without rearrangement, must spell out a word that had not appeared previously during the game. The player then uses the poached Letter Tiles to build the new word for the turn, along with any needed Letter Tiles from their Letter Tray, from the Common Pile, and from a word that is being dismantled, in any combination.

In the example shown in FIG. 20, the player poached the Letter Tiles C, O and N 860 from the Existing Word CONSTRAIN 862 and used them, along with Letter Tiles from elsewhere, to create the new word for the turn, CHRONIC 864. The newly-created Stub Word STRAIN 866 earned Bonus Points and was also scored.

Byproduct Bonus Move

With the Byproduct Move the player abuts a new word against an Existing Word in such a way that said Existing Word is transformed into a second new word entirely passively, as a byproduct—that is, without any of the Letter Tiles of said Existing Word having been moved or rearranged in any way. The byproduct word is scored along with the new word that spawned it.

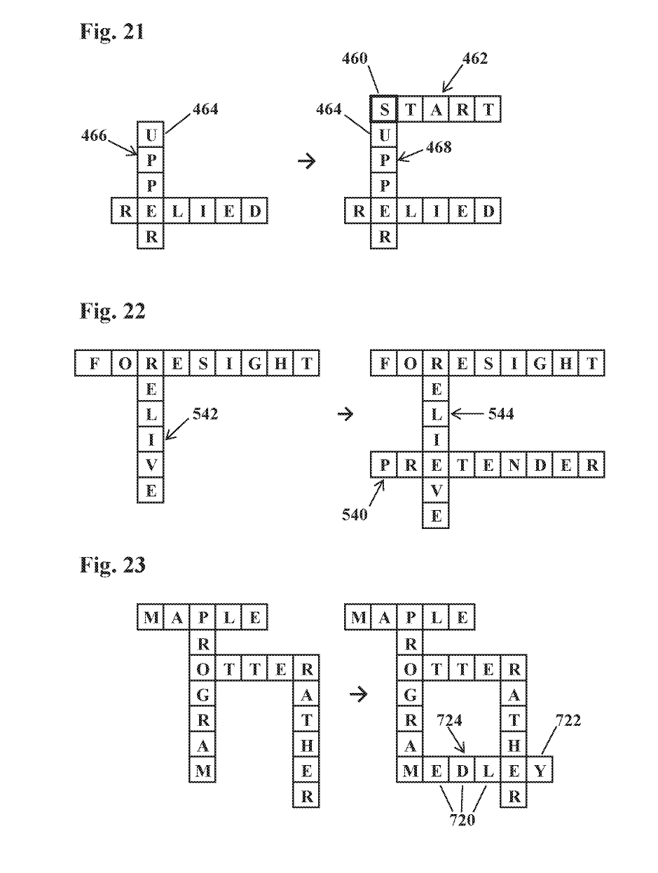

In the example in FIG. 21, the player placed the initial Letter Tile S 460 of the newly created word START 462 adjacent to the first Letter Tile U 464 of the Existing Word UPPER 466 in such a way that said Letter Tile S 460 became the Junction Letter with the incidentally created new word SUPPER 468. Both words were scored.

Insert a Word Bonus Move

With the Insert a Word Move, the player inserts an entire new word crosswise into an Existing Word in such a way as to change said Existing Word into a second new word, without any rearrangement of the Letter Tiles in said Existing Word. In the example shown in FIG. 22, the player inserted the new word PRETENDER 540 into the Existing Word RELIVE 542 in such a way as to create the new word RELIEVE 544. Both words were scored.

Square Bonus Move

With the Square Move the player joins four words together in such a way as to enclose a space that is a perfect square (all sides equal). Points are awarded for the entire word that completes the figure, and Bonus Points are scored for each of the Letter Tiles in the side that closes the square.

In the example shown in FIG. 23, the player added the new Letter Tiles E, D and L 720 from elsewhere to close the square and then added the ending Letter Tile Y 722 from elsewhere to create the new word for the turn MEDLEY 724. The player earned six points for the word MEDLEY, plus one extra point for each of the five letters MEDLE that formed the fourth side of the square—a total of eleven points for the turn.

Description of the Game's Polyanagram Plays

With any Polyanagram Play method, the player creates a new word called a “polyanagram” by using only Letter Tiles taken from two Existing Words in the Crossword Grid. The words that are dismantled may come from anywhere in the grid, and the new word may be created on any Junction Letter within any Existing Word.

Relocate a Word Polyanagram Play

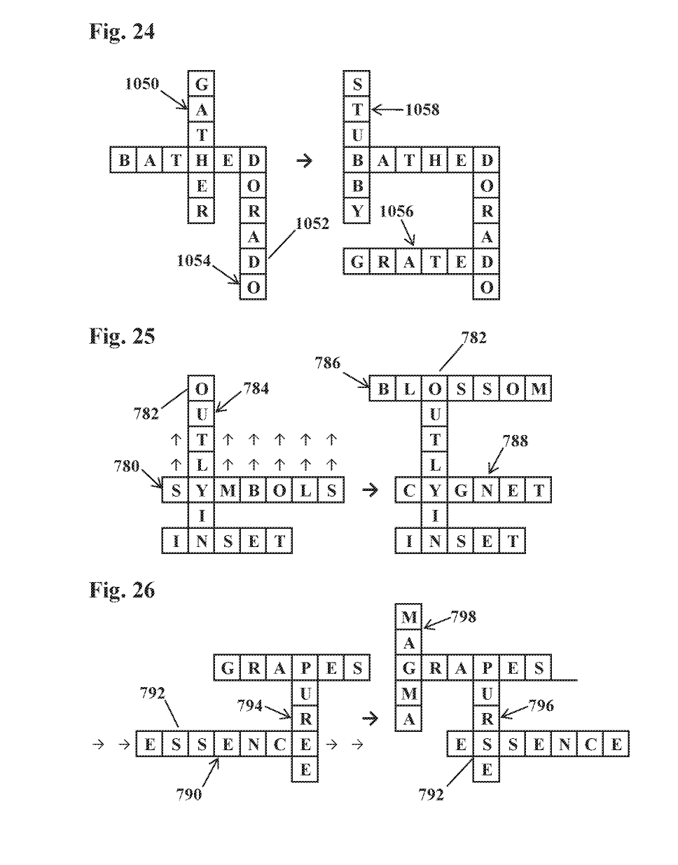

Polyanagram Plays often bear the same identifying names as Maneuvers or Moves since they achieve the same results, though by very different means. In the example shown in FIG. 24, the player executed a Relocate a Word Polyanagram Play by detaching the Free Letter Tiles of the Existing Word GATHER 1050, anagramming them, and then reattaching them to the second Letter Tile D 1052 in the Intersecting Word DORADO 1054 in such a way as to form the Polyanagram GRATED 1056, which scored Bonus Points. The player went on to create the new word for the turn STUBBY 1058. (If any letter tiles had been brought into the grid or exported from the grid, this would have been a Modify a Word Move.)

Parallel Slider Polyanagram Play

With this Polyanagram Play the player detaches the Letter Tiles of a word and slides them along (parallel to) their cross word until they come to rest on a different Junction Letter, then anagrams the slid word as necessary to create the new word for the turn. In the example shown in FIG. 25, the player detached the Letter Tiles of the Existing Word SYMBOLS 780 and slid them upward until they came to rest on the new Junction Letter O 782 in their Intersecting Word OUTLYING 784, then anagrammed them to create the Polyanagram BLOSSOM 786, which scored Bonus Points. The player then went on to create the new word for the turn CYGNET 788. (If any letter tiles had been brought into the grid or exported from the grid, this would have been a Parallel Slider Move.)

Perpendicular Slider Polyanagram Play

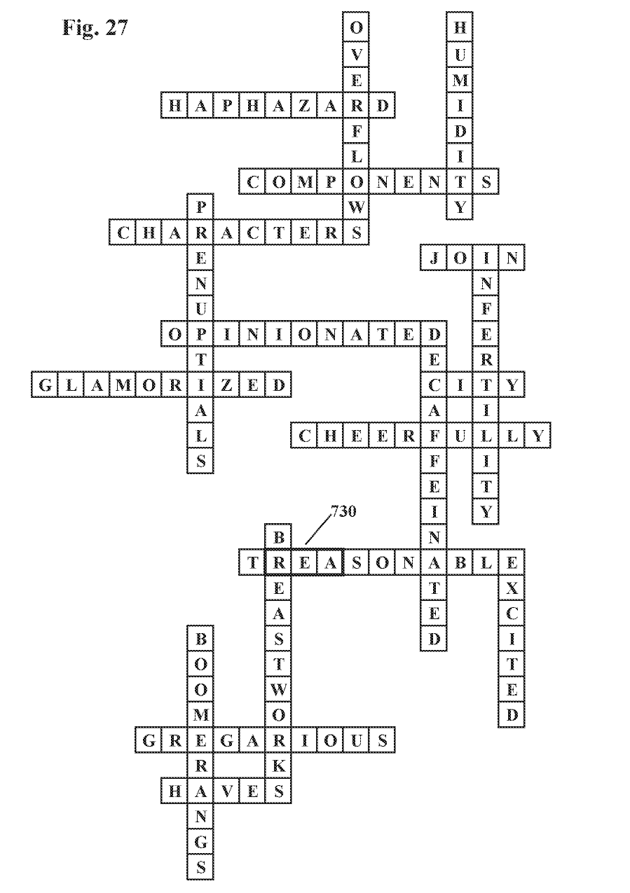

With this Polyanagram Play the player slides an entire Existing Word across (perpendicular to) its Intersecting Word in such a way that one of its component Letter Tiles becomes a new Junction Letter, with a different Character Value, in said Intersecting Word. This operation changes said Intersecting Word into a Polyanagram. In the example shown in FIG. 26, the player slid the Existing Word ESSENCE 790 to the right until its first Letter Tile S 792 became a new Junction Letter in the Intersecting Word PUREE 794, thereby changing said Intersecting Word PUREE into the Polyanagram PURSE 796, which scored Bonus Points. The player then went on to create the new word for the turn, MAGMA 798. (If any letter tiles had been brought into the grid or exported from the grid, this would have been a Perpendicular Slider Move.)

In sum, the Game's letter manipulation techniques—Maneuvers, Moves, and Polyanagrams—are the heart of this invention. In total, 18 distinct and different techniques have been disclosed and illustrated. Many other techniques can be elaborated, and those specifically disclosed here are not meant to be limiting.

Scoring

If players wish to keep score, each Letter Tile in each new word placed during a turn earns one point. Bonus points are allowed for certain plays, as described above. It is strongly recommended that players have a dictionary on hand, or an Internet connection, to verify spelling and to confirm that a candidate word indeed exists.

The question also arises as to what is a new word and what is merely a trivial variation of an Existing Word. For example, WALKED is clearly a trivial variation of WALK. Only the Letter Tiles that were added to the root of the word would be scored (in this case, the E and the D that were added to the root word WALK). When strong verbs are changed, for example SING to SANG or SUNG, only the new Letter Tiles A or U would be scored.

A variation is not trivial if it results in an entirely different word—as, for example, when WATCH is lengthened to WATCHFUL or the compound word WATCHMAN is shortened to WATCH. In such cases the resulting word is considered new, and all of its Letter Tiles are scored.

Using Two Letter Sets at Once

The Game is most enjoyable when played by only two players, since they will always be studying the Crossword Grid between turns in preparation for their next Move. The Game could be called “The Chess of Crossword Games” because it's the only game in the crossword genre in which there are many defined Moves, and also because in both games “it's always your turn” in the sense that each player needs to be visualizing their next Move while their opponent is making theirs.

The Game may be played by two or more players. With four or more players, the use of two or more Letter Sets is preferred. In a preferred embodiment, the blank faces of each set of Letter Tiles would bear distinguishing marks so that the sets are easily separated back into their original sets for single Letter Set play.

Two players may also combine two or more Letter Sets simply in order to play a longer game. The game shown in FIG. 27 was played by two advanced players using two Letter Sets. It went on for a little over three hours, in two sessions. The only vestige that remained of the first word that was played at the beginning of the game was the three-letter block REA 730, showing that the grid grew much farther upward than in another direction.

Accommodating Younger Players

One of the easiest ways to introduce younger players to The Game is to show them how to build a simple Crossword Grid. If they can form words with at least four letters, they should have a satisfying experience. The more advanced players should play with them as usual, modeling the use of The Game's Moves, Maneuvers and Polyanagrams Plays. The newer players will begin to adopt them when and as they are ready.

The players could decide not to keep score at all. Otherwise, the beginners could score their moves as usual, while the more advanced players employed one of the following alternate scoring systems for themselves:

At Scoring Level 1 (Beginner or “Sixes”), no word earns more than six points, regardless of how many letters it contains. Players may create longer words, but they will still earn only six points.

At Scoring Level 2 (Intermediate or “Eights”), no word earns more than eight points, regardless of how many letters it contains. Players may create longer words if they wish, but they will still earn only eight points.

At Scoring Level 3 (Advanced or “Tens”), no word earns more than ten points, regardless of how many letters it contains. Players may create longer words, but they will still earn only ten points.

No matter what Scoring Level is being used, the more experienced players should continue to create longer and more interesting words as usual. That would be educational, informative and inspirational to the younger players, without overwhelming their scores.

Other Voluntary Restraints

Skilled players may also account for variations in ability among players by setting higher standards for themselves, for example through the use of one or more of these techniques:
By adhering to a higher minimum length for the words they create, such as six or seven letters
By refraining from calling out and scoring anagrams (though they may alert the other player when they've spotted one in the Crossword Grid)
By declining to claim Bonus Points
By starting out with a negative score
By working only with Letter Tray letters and Common Pile letters, forgoing the big scores that are possible when dismantling long words that are already in the Crossword Grid.

Alternate Embodiments of the Game

Although the preferred embodiment of The Game uses square Letter Tiles, that shape is not limiting. The Rules, Moves and Maneuvers of The Game may be modified to accommodate movable Letter Tiles of other shapes for example, hexagons.

Furthermore, the present application discloses not just one game, but an entire suite of games. Small changes in the basic Rules of The Game may result in major changes in game play, point scores, and the resulting Crossword Grid. A non-limiting summary of some game variants is as follows:

1) Quick Start

This is a good choice when time is limited. For the first part of the game, new words earn only six points, no matter how many Letter Tiles they contain. This process continues until less than six letters remain in the Stockpile, at which point most of the Letter Tiles in the Letter Set are in play. From that point on, the players will cannibalize the many short Existing Words as the Crossword Grid consolidates.

2) Short Stuff

This is another good choice when time is limited. The players first decide how many Letter Tiles they wish to play, and use only that many when they establish the Stockpile.

3) Draw a Blank

Select a Letter Tile, put tape over its letter character, and play it as a blank Letter Tile, with the taped side down. The Letter Tiles J and Q (and to a lesser extent, X and Z) are the ones that are most often left over at the end of a game, and that will therefore be missed the least. Place the blank tile into the Common Pile at the very beginning of the game. After that it will cycle into and out of the grid, just like any other Letter Tile.

The blank tile can substitute for any letter, but can have only one value when it is serving as a Junction Letter. Any player may redeem the blank tile from the Crossword Grid by replacing it with a Letter Tile that has the same Character Value, but they must then use it during the same turn. Since the blank tile often makes it possible to form a desired word, the players will make correspondingly less use of The Game's Moves, Maneuvers and Polyanagram Play. As a result, game play will likely move along a little more quickly, but may not be quite as challenging.

4) Theme Park

This game is played as usual except that the players choose a theme before beginning. The theme can be anything—Towns, Foodstuffs, Birds, etc. Words that follow the theme score Bonus Points (in the above examples, words like MEMPHIS, PASTRAMI, and SANDPIPER). In this variant, a player's imagination can definitely triumph over the impressiveness of their opponent's vocabulary.

5) One Up

Players start with empty trays and an empty Common Pile. Drawing a letter constitutes a turn, placing a word in the grid constitutes a turn, and discarding a Letter Tile and drawing a new one from the Stockpile constitutes a turn. The game play of this embodiment requires the players to manage their letters strategically—for instance by deciding whether to create a new word for the turn or, instead, to continue drawing Letter Tiles in hopes of creating a longer word later. Players may also strategically delay any move that results in the placement of leftover Letter Tiles into the Common Pile, since said Letter Tiles would then be available to their opponent.

6) Solitaire Challenge

A challenging game for one is to play without a Letter Tray and to start with an empty Common Pile. The player turns up one Letter Tile at a time until they are able to complete the first word of the new Crossword Grid. Any Letter Tiles that remain form the Common Pile. Scoring begins at that point.

The player continues to turn up one letter at a time and tries to fit each one into the Crossword Grid, no matter how many words have to be taken apart and rebuilt in order to do so. If this is not possible, the player places any unused Letter Tiles into the Common Pile, records a score of minus 1, and proceeds to turn over another Letter Tile. Play continues in this way until the Stockpile and the Common Pile are both empty and no more words can be formed. The player scores minus 1 point for each Letter Tile that remains in the Common Pile. Over time, the player can compare scores and try to achieve a new personal best each time, the best score being the one nearest zero.

7) Longfellow

In this variant, any word that is modified must be lengthened by at least one Letter Tile. This naturally leads to a final grid with significantly longer words. It also eliminates “churning”, whereby the same letters are used over and over (as in the series BONE, CONE, DONE, GONE, LONE, NONE, PONE, SONE, TONE, ZONE.). Under this option, the series might instead be HONE, THOSE, SHOVEL, SLOVENLY, ENVELOPED, UNLEAVENED, AVALANCHES. (Anagrams are excepted from the rule, so HOVELS would have been allowed.)

8) Poetry

A new word that rhymes with another word that is in the Crossword Grid at the same time earns Bonus Points.

9) TBS (Turn-based Scoring)

In this variant, competitors play under the standard rules, using the same random variation of the Letter Set, under the Longfellow Option. They calculate their final scores in the usual manner; divide that number by the number of turns that were played; multiply the result by 10; round the product to zero decimal places; and finally subtract the number of tiles left in the Common Pile. For example, if a person racked up 107 points in 12 turns and left two tiles in the Common Pile, the turn-based score would be [(107/12)×10]−2=87.

Changing the scoring system in this way induces radical changes in game play and strategy by encouraging the longest possible words, anagrams, and techniques that generate Bonus Points, always with an eye toward incorporating the most difficult-to-place Letter Tiles early in the game to minimize the chances that said difficult-to-place Letter Tiles will remain in the Common Pile at the end of the game.

10) Tournament

This specification discloses 18 Moves, Maneuvers and Polyanagram Plays. However, more than fifty letter manipulation techniques are currently known, and all of them may be used in this variant. In a competitive matchup, players might first play one round under the standard rules, then a themed game, then a standard game using turn-based scoring, then an anything-goes game under Tournament rules, and finally another round under the standard rules. For each game in the series, the 80 Letter Tiles would be fed into the Stockpile in exactly the same order for all players.

Virtual Embodiments

This discussion of the Preferred Embodiment is not limiting. In particular, The Game is readily adaptable to an electronic version, suitable for play over the Internet either alone or against another person. FIG. 28 is a simulation of the screen of one possible electronic embodiment of The Game at a particular moment in the game play. The elements shown are the Crossword Grid Panel 800, the Letter Tray Panel 802, the Common Pile Panel 804, five Move icons 806, the Stockpile Counter 808, the Zoom In and Zoom Out buttons 810, and the OK Button 812.

The code would be optimized for use on screens of any size, from smart phones to computers. The player places Letter Tiles in the Crossword Grid by dragging and dropping them, using a mouse or a trackpad. In order to bring more usable space into view, they can zoom the display or drag the grid in any direction.

In consideration of the need for the player to select Letter Tiles with a fingertip and move them around on devices with smaller screens, the digital game uses only 50 Letter Tiles. The Stockpile Counter 808 presently indicates that 15 letters are still available. The player is planning to draw on virtual letters from the Letter Tile and the Common Pile to enter the new word REMINDS, using as a Junction Letter the Letter Tile with the Character Value ‘S’ in the word ‘SCORED’ shown within the Crossword Grid 800.

When a new word is properly attached to an Existing Word in the Crossword Grid and is recognized by the onboard dictionary, its component letters turn from black to blue. When the player clicks the OK Button 810, the letters turn green to match the rest of the letters in the grid. Images of Letter Tiles then glide from the Stockpile Counter icon 808 to refill the Letter Tile and then the Common Pile, in that order. The count of letters remaining in the Stockpile diminishes accordingly.

The Move icons 806 allow the player to manipulate Letter Tiles that are already in the Crossword Grid. By clicking the J icon, for example, the player signals the code that they are planning to execute a Junction Letter Move. The player will then click the intended Junction Letter in the Crossword Grid, in this case the Letter Tile with the Character Value ‘R’ in the word ‘SCORED’ shown within said Crossword Grid 800. That letter ‘R’ immediately glides back to the stockpile, leaving an empty space which the player then fills with a Letter Tile ‘P’ from the Common Pile. This transforms the Existing Word ‘SHARE’ shown within said Crossword Grid 800 into the new word ‘SHAPE’, and simultaneously changes the Existing Word ‘SCORED’ into the new word ‘SCOPED’. Since the Stockpile operates on a “last in, first out” basis, the now-empty space in the Common Pile is refilled with the Letter Tile with the Character Value ‘R’ that was removed from the Crossword Grid during the turn, exactly as it would have been had this round of The Game been played with physical Letter Tiles.

Another virtual embodiment would be as a dedicated handheld electronic device that is programmed with the game mechanics, an updatable electronic dictionary, and special files holding words that follow prescribed themes (as discussed under the variant Theme Park above).

Such a device would have considerable educational value as a means of learning proper spelling, whether used by schoolchildren or by people of any age or nationality who wish to improve their skills in (for example) English.

Final Notes

It is to be understood that the preferred embodiment and other embodiments of this disclosure are merely illustrative of and not restrictive upon the broad invention, and that this invention is not limited to the specific constructions or arrangements shown and described herein. Many modifications and variations of this invention itself may be made without departing from its spirit and scope. In addition, the embodiments of the Moves, Maneuvers and Polyanagram Plays shown here are offered as examples only and are not intended to be limiting, as will be appreciated by those skilled in the art.

I claim:

1. A method of playing a crossword and anagram game, without a game board, further comprising the steps of:
(a) spreading a determined number of letter tiles face down out on a playing surface to form a stockpile, each of said letter tiles having a letter of the alphabet on one face, the other face being blank;
(b) players each drawing one of said letter tiles from the stockpile in order to determine the order of play, the player drawing the letter tile with the letter closest to the beginning of the alphabet taking the first turn, play thereafter passing to the left;
(c) players returning said drawn letter tiles to said stockpile, face down, scrambling the letter tiles of said stockpile, each player then drawing a determined number of said letter tiles and placing said drawn letter tiles onto letter trays configured to hold said letter tiles in a semi-upright position, out of sight of other players;
(d) the first player turning a determined number of said letter tiles in said stockpile face up on the playing surface to form a common pile, the component letter tiles of said common pile thereafter being available to each player at every turn throughout the game;
(e) said first player then placing said letter tiles onto said playing surface to form a word, said word comprising no fewer than four letter tiles, said letter tiles having been drawn from said first player's letter tray and from said common pile in any proportion, said first player then scoring said new word at the rate of one point for each letter tile in said new word;
(f) said first player first refilling their individual letter trays to their determined capacity, and then refilling the common pool to its determined capacity;
(g) subsequent players then adding additional words to build a crossword grid by either:
(i) adding a new word perpendicularly to any existing word in said crossword grid, crossword fashion, any letter tile of said first word serving as the junction letter that is shared by both words; or:
(ii) changing an existing word in said crossword grid into a different word by any combination of adding letter tiles and removing letter tiles that are selected from their letter tray or from said common pile in any proportion, and placing said removed letter tiles into said common pile; or:
(h) subsequent players always being permitted to anagram the letter tiles of any existing word on their own junction letter, scoring one bonus point for each letter in said anagram and then continuing on to form a new word for the turn;
(i) players passing if they are unable to form a new word;
(j) game play continuing in this manner until said stockpile is empty and all players have passed in turn; all players then emptying their individual letter trays into said common pool;
(k) game play resuming under a new constraint that the spelling of existing words may not be changed except by addition of a prefix and/or a suffix, new words otherwise being formed only by placing letter tiles alongside or between letter tiles in said existing words;
(l) the game ending when all players have again passed in turn, the winner being the player who has scored the most points.

2. The method of playing a game according to claim 1 wherein a player may detach the letter tiles of two existing words from their intersecting words and use said detached letter tiles to create a single new word.

3. The method of playing a game according to claim 1 wherein a player acquires a single letter tile having a desired character value by detaching the letter tiles from their junction letter within their intersecting word, one of said detached letter tiles having said desired character value; the player then using said detached letter tiles to reconstitute said existing word as a stand-alone entity, such reconstitution requiring a copy of said junction letter tile, said copy coming from said player's letter tray or from the common pool; player then reattaching said reconstituted word to a second existing word, choosing a junction letter having said desired character value, whereby the letter tile of said reconstituted word having said desired character value, being a duplicate, is left over and is then used during the same turn in creating a new word.

4. The method of playing a game according to claim 1 wherein a player removes an original junction letter tile that unites two existing words in said crossword grid and then replaces said original junction letter tile with a letter tile that has a different character value than said original junction letter, whereby the spelling of both of the two said existing words is changed, with the result that two new words are created simultaneously during a single turn, the player scoring one point for each letter in each new word.

5. The method of playing a game according to claim 1 wherein a player selects a number of letter tiles from their individual letter tray and/or from said common pool, in any combination; arranges them in such a way as to form a complete free-standing new word; and then abuts said free-standing new word against an initial or a terminal letter of an existing word in said crossword grid, crossword fashion, in such a way that the letter tile in said free-standing new word that abuts said initial or said terminal letter tile in said existing word becomes a new initial letter tile or a new terminal letter tile of said existing word, whereby the spelling of said existing word is changed, transforming said existing word into a second new word, strictly as a byproduct of the manner in which said free-standing new word was placed, none of said existing word's own component letter tiles having been moved or rearranged.

6. The method of playing a game according to claim 1 wherein a player inserts a free-standing new word as a unit, crossword fashion, into an existing word in such a way that one of said letter tiles in said free-standing new word becomes a junction letter within said existing word, whereby the spelling of said existing word is changed, transforming said existing word into a second new word.

7. The method of playing a game according to claim 1 wherein a player detaches the letter tiles of an existing word from their junction letter and rearranges said letter tiles in such a way as to create an anagram of said existing word on said junction letter, said anagram being scored as a new word, the player then going on to create a new word in the usual manner during the same turn.

8. The method of playing a game according to claim 1 wherein a player detaches the letter tiles of two existing words from their junction letters and rearranges said letter tiles in such a way as to create a single new word on a junction letter in any existing word, no letter tiles having been added from elsewhere and no letter tiles have been removed, said new word being known as a polyanagram.

9. The method of playing a game according to claim 1 wherein a player selects letter tiles from an existing word in the crossword grid, from their letter tray and from a common pool of available letter tiles, in any combination; the player then placing said letter tiles in such a way as to abut two letter tiles in two existing words, whereby said abutted letter tiles both become new junction letters in a new word, said new word forming the fourth side of a perfect square consisting of four words of equal length, the last letter tile of each of said four words being also the first letter tile of an intersecting word, said player scoring one bonus point for each of the letter tiles in said side, in addition to one point for each letter tile in the new word as a whole.

10. The method of playing a game according to claim 1 wherein a player joins letter tiles to form a phrase, the individual component words of said phrase being joined end to end without spaces, said phrase being reattached to a selected junction letter tile in an existing word, said junction letter becoming one of the component letter tiles of one of the words of said phrase, whereby multiple words are added to said crossword simultaneously during a single turn.

11. The method of playing a game according to claim 10 wherein a player adds a phrase that contains an ampersand to the crossword grid, said ampersand being omitted.

12. The method of playing a game according to claim 1 wherein a player adds a new word to the crossword grid, said new word containing a hyphen or an apostrophe, said hyphen or apostrophe being omitted.

13. The method of playing a game according to claim 1 wherein prior to adding a new word, a player detaches the letter tiles of an existing word from their original junction letter and reattaches said letter tiles, without rearrangement, to a new junction letter in any existing word, said new junction letter having the same character value as said original junction letter, whereby said existing word is moved to a position where it no longer impedes the placement of said new word in the vicinity of said original junction letter.

14. The method of playing a game according to claim 13 wherein all intersecting words that are attached to said existing word are also relocated, as a group.

15. The method of playing a game according to claim 1 wherein the detached letter tiles of an existing word that is being relocated to a junction letter elsewhere in the crossword grid are reattached in such a way that said existing word is transposed between horizontal and vertical orientation, or vice versa.

16. The method of playing a game according to claim 1 wherein the letter tiles adhere to a blank magnetic playing surface, whereby said surface may be rotated such that each player in turn views said crossword grid right side up, said magnetic attraction preventing said letter tiles from sliding out of position as said playing surface is rotated.

17. The method of playing a game according to claim 16 wherein said surface is provided with grid lines indicating the locations of its embedded magnets, said grid lines also serving to maintain the rows and columns letter tiles in said crossword grid in an orthogonal relationship with the edges of said playing surface.

18. The method of playing a game according to claim 16 wherein additional magnetic surfaces are provided for holding the letter tiles of said stockpile and of said common pile.

19. The method of playing a game according to claim 16 wherein said surface may be folded for portability.

20. The method of playing a game according to claim 1 wherein said playing surface is the screen of an electronic device, and said crossword grid, said letter tiles, said letter trays and said common pile are all digital representations of their physical counterparts.
